(19) United States
(12) Patent Application Publication
(10) Pub. No.: US 2018/0114233 A1
(43) Pub. Date: Apr. 26, 2018

(54) SYSTEM AND METHOD FOR FACILITATING MANAGEMENT OF BUSINESS OPERATIONS

(71) Applicant: Energy One Limited, North Sydney, NSW (AU)

(72) Inventors: Charles Shaun ANKERS, Freshwater, New South Wales (AU); Ross James ATTRILL, Dee Why, New South Wales (AU)

(21) Appl. No.: 15/565,601

(22) PCT Filed: Apr. 11, 2016
(86) PCT No.: PCT/AU2016/050264

§ 371 Date: Oct. 10, 2017

(30) Foreign Application Priority Data
Apr. 10, 2015 (AU) 2015201823

(51) Int. Cl. G06Q 30/02; G06Q 10/06

(52) U.S. Cl. CPC G06Q 30/0201; G06Q 10/063

(57) ABSTRACT

The present invention relates to a system and method for facilitating management of business operations, particularly, but not exclusively, for facilitating management of energy trading operations. The system comprises a business management process which is arranged to enable the design of business process steps for managing operations. It also includes an algorithm design process arranged to enable design of algorithms for processing of data associated with one or more of the business process steps. This enables the creation of a holistic implementation system, which implements the operations of the business, including data processes for obtaining, calculating and outputting data.

### FIELD OF THE INVENTION

The present invention relates to a system and method for facilitating management of business operations and, particularly, but not exclusively, to a system and method for facilitating management of energy trading operations.

### BACKGROUND OF THE INVENTION

The carrying on of many businesses requires a number of complex, day-to-day operations. Computing systems to facilitate business process management (business process management systems, “BPM”) have been developed. These are often generic systems, that enable design of day-to-day business processes that the workforce can follow. They are usually forms-based, and manage compliance with the business process based on the workforce accessing the forms and updating fields in the forms. Documents may be generated (based on the forms) to facilitate business processes.

BPMs therefore allow business processes to be organized and enable the production of documentation. The majority of BPMs have no or limited facility for managing data based processes, however. If a business process requires, as a step in the process, data to be obtained, managed, processed, used as part of a calculation, this is usually done manually, with the assistance of other tools (e.g. spreadsheets).

Many businesses may cobble together a number of systems, including BPM, spreadsheets, bespoke systems, other tools and manual processes to deal with day-to-day operations.

Many businesses may develop specific solutions for data gathering and business process automation steps. These processes and steps may be linked or facilitated by the use of bespoke software. These solutions are usually bespoke to the required business process and are not usually intended or designed to be easily amended for a multiplicity of business operations processes.

Furthermore, specific software products exist for completion of specific (often standardized or frequently occurring) business processes. These products may complete the automation of complex business processes. However they are usually process-specific, limited to the most popular business operations and do not facilitate the automation of a wide variety of differing and irregular tasks and processes.

The energy trading operations business is one example of a business which requires many complex tasks to implement operation day to day. For example, in gas trading operations, a trading operations group may be required to carry out a number of complex tasks periodically. In some cases the tasks may need to be repeated in short time periods (hourly or half-hourly), 24/7. Tasks may include: obtaining data on parameters that may affect trade (e.g. weather, market conditions, availability of gas transport, etc.); determining current contract positions (how much gas has been made available via contract, what is the cost, what contracted transport is available, etc.); calculating the likely demand for an upcoming time period (this can require complex calculations and sometimes manual “intuition”); adjusting the position (e.g. adjusting contracts, buying/selling more gas, adjusting storage portions, etc.); messaging to external parties to ensure that the requirements are adjusted, e.g. emails, data messaging, etc.); repeating the process for the next time period to be updated; storing records and documents in an auditable, time-stamped database, for example, to allow for the reconstruction of the entire business process logic and lifecycle, if necessary.

Energy companies often employ large energy trading operations groups with highly paid, skillful personnel to implement the operations.

Even with highly skilled personnel, mistakes are often made. This can lead to cost and loss of profit e.g. the need to buy energy at expensive, spot rates because of an error. It can also lead to lack of compliance with regulations which can have severe consequences for the company.

Although generic BPM tools are available to assist with planning and compliance with business processes, they do not deal with data processing, complex calculations, integration or two-way communication with external databases or market gateways or external counterparties, or the actuation of those tasks within the business processes. In the main, they merely provide task lists for operators to follow and documentation associated with the tasks, for the operators to complete. Much of the implementation of the tasks (e.g. obtaining data, calculating, communicating) require manual input by the workforce, perhaps with the aid of other tools, such as spreadsheets, or purpose built software.

### SUMMARY OF INVENTION

In accordance with a first aspect, the present invention provides a system for facilitating management of business operations, comprising a computer having a processor, a memory, and an operating system for implementing computer processes, a business management process, arranged to enable the design of business process steps, and an algorithm design process, arranged to enable design of algorithms for processing of data associated with one or more of the business process steps.

In an embodiment, the business management process is arranged to design business process steps for a plurality of tasks. The tasks may be arranged in a particular order. The tasks may include one or more tasks requiring implementation of an algorithm. The algorithm may be arranged to perform a calculation based on data associated with one or more of the business process steps.

In an embodiment, the algorithm design process comprises an arithmetic expression language.

In an embodiment, the system comprises a data design process, arranged to enable design of data processes. Data processes may include data capture and data delivery.

In an embodiment, the system has data integration functionality to gather, process and disseminate data.

In an embodiment, the algorithm design process and the data design process are configured to manage time series data. Time series data is data or data sets that repeat at intervals such as every 5, 30 or 60 minutes or daily. In the energy industry, for example, time series data is ubiquitous. In an embodiment, the system stores time series data in a time series database. The algorithm design process enables configuration of algorithms in this embodiment that operate on time series data to produce an output during the business management process steps. The storage, management and manipulation of time series data has particular advantage where the system is applied to facilitate management of business operations in industries such as energy trading.

In an embodiment, the system comprises a document management process, enabling the design of document management tasks. Document management tasks may include automatic preparation of documents.

In an embodiment, the system comprises a communications management process, enabling the design of communications tasks. The communications tasks may include communications with external parties, and the monitoring of communications with external parties. In an embodiment, the system has communications functionality to enable communications, for example, with external computing systems.

In an embodiment, the system comprises a recording process, able to capture, and store data for record keeping purposes. The recording process may be arranged to time-stamp stored data.

In embodiments, the system has the advantage of combining business process design with algorithmic process design and data process design, enabling the design of business processes to manage and implement the majority of aspects of complex business operations. For example, in energy trading operations, an energy operations management system can be designed utilizing the system of the present invention. The energy operations system can be designed to deal with all energy trading operations, likely to be encountered in a variety of energy trading markets and for a variety of purposes across the world. The business management process can be utilized to design energy trading process steps. The algorithmic design process can be used to design calculations to determine requirements for varying demand, for varying contract positions, etc. Document management processes and communications management can organize messages for updating contract positons, for example. Data process design can design data processes for obtaining required data for calculations. For example, weather conditions data or market or business-specific data may be obtained for input to a calculation for determining the likely energy demand.

A system in accordance with an embodiment of the present invention can advantageously design and implement business processes, calculation processes, messaging and communications, to give complete support for any complex business operations.

In an embodiment, the system is arranged to facilitate management of energy trading operations. The business management process is arranged to enable the design of business process steps for energy operations and the algorithmic design process is arranged to enable design of algorithms for calculation of energy operations requirements. The data design process is arranged to design data flow processes for obtaining and dealing with data relating to energy operations.

The system is not limited to application in energy trading operations. It can be applied in any complex operations business. For example, it can be applied in the insurance business (logging and monitoring of claims, determining claim outcomes), the materials commodities business (mining products, delivery and supply), and any other complex operations business.

In accordance with a second aspect, the present invention provides a method for facilitating management of business operations, comprising the steps of using a business management process to design a plurality of business process steps, and using an algorithmic design process to design algorithms for processing of data associated with one or more of business process steps, and implementing the designed process steps and algorithms to facilitate business operations.

In an embodiment, the business process steps are steps for facilitating energy trading operations, and the algorithms are for implementing calculations to determine energy trading operations positions.

In accordance with a third aspect, the present invention provides a computer program, comprising instructions for controlling a computer to implement a system in accordance with the first aspect of the invention.

In accordance with a fourth aspect, the present invention provides a computer readable medium, providing a computer program in accordance with the third aspect of the invention.

In accordance with a fifth aspect, the present invention provides a data signal, comprising a computer program in accordance with the third aspect of the invention.

In accordance with a sixth aspect, the present invention provides a system for facilitating management of energy trading operations, comprising a computer having a processor, a memory, and an operating system for implementing computer processes, a business management process, arranged to enable design of business process steps for facilitating energy trading operations, and an algorithm design process, arranged to enable the design of algorithms for processing of data associated with one or more of the business process steps, the algorithms being arranged for calculation of energy trading positions in an energy operations business.

In accordance with a seventh aspect, the present invention provides a method for facilitating management of energy trading operations, comprising the steps of utilizing a business management process to design a plurality of business process steps for facilitating energy trading operations, and utilizing an algorithmic design process for designing algorithms for processing of data associated with one or more of the business process steps, the data and the algorithms being arranged for calculation of energy trading positions in an energy operations business.

In accordance with an eighth aspect, the present invention provides a computer program, comprising instructions for controlling a computer to implement a system in accordance with the sixth aspect of the invention.

In accordance with a ninth aspect, the present invention provides a computer readable medium, providing a computer program in accordance with the eighth aspect of the invention.

In accordance with a tenth aspect, the present invention provides a data signal, comprising a computer program in accordance with the eighth aspect of the invention.

In accordance with an eleventh aspect, the present invention provides an energy trading operations system, comprising business process steps for facilitating energy trading operations and algorithms for processing of data associated with one or more of the business process steps, the business process steps and algorithms being designed by the system in accordance with the sixth aspect of the invention.

In accordance with a twelfth aspect, the present invention provides a computer program, comprising instructions for controlling a computer to implement a system in accordance with the eleventh aspect of the invention.

In accordance with a thirteenth aspect, the present invention provides a computer readable medium, providing a computer program in accordance with the twelfth aspect of the invention.

In accordance with a fourteenth aspect, the present invention provides a data signal, comprising a computer program in accordance with a twelfth aspect of the invention.

In accordance with a thirteenth aspect, the present invention provides a system for facilitating management of business operations, comprising a computer having a processor, a memory, and an operating system for implementing computer processes, a business management process arranged to enable the design of business process steps, and an algorithm design process arranged to enable the design of algorithms for processing of data associated with one or more of the business process steps, the algorithm design process being configured to manage operation of time series data.

In accordance with a fourteenth aspect, the present invention provides a computer program, comprising instructions for controlling a computer to implement a system in accordance with the thirteenth aspect of the invention.

In accordance with a fifteenth aspect, the present invention provides a computer readable medium, providing a computer program in accordance with the fourteenth aspect of the invention.

In accordance with a sixteenth aspect, the present invention provides a data signal, comprising a computer program in accordance with the fourteenth aspect of the invention.

### BRIEF DESCRIPTION OF DRAWINGS

Features and advantages of the present invention will become apparent from the following description of embodiments thereof, by way of example only, with reference to the accompanying drawings, in which:

FIG. 1 is a flow diagram, illustrating a high level overview of business process steps that may be implemented for energy trading operations;

FIG. 2 is a schematic diagram illustrating a system in accordance with an embodiment of the present invention;

FIG. 3 is a flow diagram illustrating a business process which may be designed and implemented by a system in accordance with an embodiment of the present invention;

FIGS. 4 to 10 are representations of computer displays illustrating aspects of an energy trading operations process implemented by a system in accordance with an embodiment of the present invention;

FIG. 11 is a figure illustrating a Gas Nomination Process utilising a system in accordance with an embodiment of the present invention;

FIG. 12 is an illustration of a business process utilising a system in accordance with the present invention; and

FIGS. 13 to 23 are entity relationship diagrams for data models for components of the system of an embodiment of the invention.

### DETAILED DESCRIPTION OF EMBODIMENTS OF THE INVENTION

Energy trading operations are one example of a complex business which requires a series of business process steps, obtaining and processing data, and dealing with communications to third parties.

In the energy supply business, energy trading operations are used to efficiently meet energy demand in a cost-effective manner.

An energy supplier/retailer will usually have a number of contracts in place for the supply of energy. Depending on conditions that may affect demand for the energy during a particular time period, the energy trader's contract position may need to be adjusted in order to ensure that they can supply the right amount of energy over the time period, at the best possible price.

The process of determining demand and adjusting the trading position may need to be repeated regularly. For gas trading operations, for example, the position may need to be updated at intervals as small as half-hourly. Energy supply firms and retailers may have in-house energy trading operations groups whose entire task is to ensure that the energy operations position is optimal. These groups may work in shifts, 24/7.

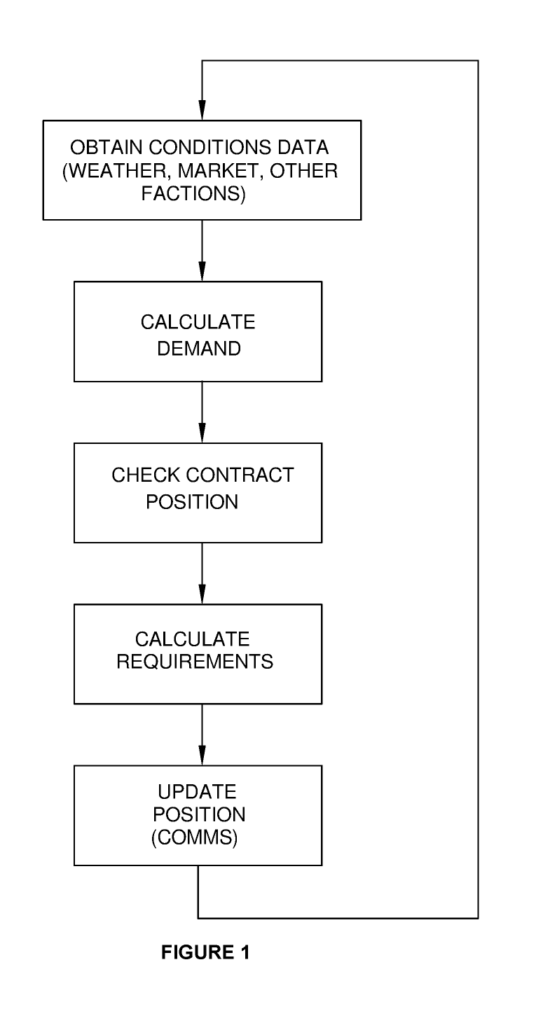

FIG. 1 is a “high level” flow diagram of a typical business process for energy trading operations.

In gas trading operations, for example, a typical series of tasks for gas operations personnel may be as follows:

Step 1, in order to determine likely energy demand, it is necessary to obtain data for parameters that are likely to affect demand in the designated time period. Relevant parameters may include the weather e.g. temperatures, wind speed, humidity. They may include “on the ground” conditions, such as bushfires, transport problems (e.g. maintenance of pipelines), and other conditions which may affect the supply of energy. They may include any data that is likely to affect energy supply and demand.

Much of this data will be gathered manually e.g. by checking newsfeeds, websites, etc. Some data may be gathered by reference to automated collection and compilation processes, which may be offered as “feeds” by data suppliers or automated in other manner.

At step 2, once all the data has been gathered, calculations must be made of the likely demand for energy for that particular time period. Calculations are usually done manually with the aid of tools, such as spreadsheets. There is also considered to be a certain amount of “skill” and “intuition” required by the operator in calculating the likely demands.

At step 3, the operator checks their contract position. For gas operations, for example, they will need to ensure that there is enough contracted supply of gas to satisfy demand. They will also need to ensure that transport is available to transport the gas e.g. trucks, pipelines. If there is not sufficient contract position to satisfy demand, then the operator will need to adjust the position. They may also need to adjust position if they have too much gas and supply contracted i.e. an oversupply. They may need to sell off.

At step 4, the likely requirements are calculated, given the current contract position and the likely demand. Again these calculations can be complex and require a lot of skill. They are generally carried out manually, with the assistance of tools, such as spreadsheets.

At step 5, once the requirements are calculated, it is necessary to update the position e.g. update the contract position to obtain more energy, more transport, etc. This usually requires messaging with customers/suppliers. This is currently generally done manually, by e-mail, facsimile, by the transfer or by accessing B2B websites.

The process must then be repeated for the next time interval for which gas supply is to be managed.

Energy trading operations are complex, require many tasks and calculations. They require the obtaining and processing of data. They also require sending and tracking communications to ensure that positions are correctly updated.

There is a high level of risk involved. If a trader makes an error, this can be very costly. For example, if a trader makes an error in calculation so that there is not enough energy to satisfy demand, it may be necessary to purchase the energy at a relatively high (spot) price. This can lead to a drop in profit for the company. There are also many regulations which energy trading operators must comply with. Non-compliance can lead to penalties (fines and other penalties) and a poor reputation in the marketplace.

As discussed above, business process management tools (BPMs) are available which can assist in organising the work processes. They can also provide documentation associated with the work processes. They do not facilitate data capture or calculation, however, or calculation of energy positions. Such highly skilled work is left to the traders and any additional tools that they may wish to use. Some business software tools may be available to complete common or standardised processes, but lack the ability to automate a wide variety of non-standard processes.

The training of operators in the energy trading operations market is difficult and is not consistent. Different traders may get different results. It is a highly skilled and expensive occupation.

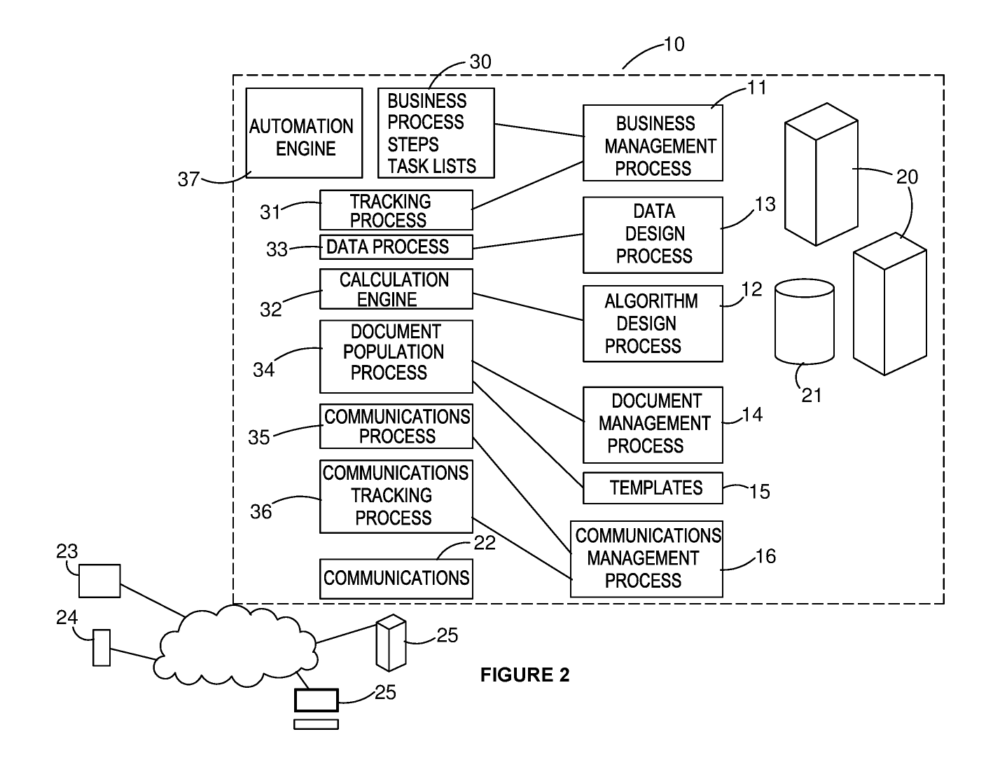

FIG. 2 is a schematic diagram illustrating a system in accordance with an embodiment of the present invention, for facilitating management of business operations. The system is suitable for managing complex business operations such as those required for energy trading and logistics operations. It is also suitable for managing complex business operations in other fields. It is suitable for managing any business operation which requires obtaining and processing of data, the application of complex logic or conditional decision support rules and preparation and tracking of documents.

In this embodiment, the system comprises a business management process 11, which is arranged to enable the design of business process steps. It also comprises an algorithm design process 12 which is arranged to enable design of algorithms for carrying out processing of data associated with one or more of the business process steps.

In this embodiment, the system is arranged to make complex and conditional business decisions based on pre-configured logic with a wide array of variables such as data inputs that vary over time (time series data), often found in complex business processes.

In more detail, referring to FIG. 2, the system 10 comprises a computing system 20, which includes a processor and memory (this may comprise a plurality of processors and types of memory, such as disc, RAM, etc.). In this embodiment, the computer 20 comprises one or more servers housed in the “cloud”. The system comprises an operating system. The servers 20 together with the operating system and associated software implement the computer processes, including the business management process 11 and the algorithm design process 12, and the other computer processes to be described below. The computer processes may be implemented as separate modules, which may share common foundations such as routines and sub-routines. The computer processes may be implemented in any suitable way and implementation is not limited to separate modules as illustrated in FIG. 2. Any software/hardware architecture that implements the functionality of the processes as described, may be utilised.

The servers also implement a database 21, arranged to store data, including documents, data to be processed, communications data and any other data.

Time series data (discussed in more detail later on) is stored in database 21 as a time series database, being a simple relational data model. The system of this embodiment saves most of its data into database table(s) within a relational database.

Communications interface 22, which may be implemented by any appropriate combination of hardware and/or software, is arranged for communicating with local client computers 23 and remote computers or mobile devices, smartphones and the like 24. Communication may be by any communications media, such as wireless, internet or any appropriate media. The local terminals 23 and remote terminals 24 may be operated by users of the system 10 to interface with the system 10.

Communications 22 also enables the system 10 to communicate with third party systems 25, of which there may be many. These may include third party computing systems, PCs, mobile devices, and may also include data providing systems, such as website and other data provision systems. Communications 22 can communicate with system users and third party systems in order to implement business operations.

Referring again to FIG. 2, the business management process 11 is arranged to enable the design of business process steps 30. In this embodiment, the business process steps 30 include one or more tasks. In this embodiment, which is arranged to implement an energy trading operations business, the business management process 11 is arranged to design task lists 30 for organising energy trading operations. It is also arranged to design a tracking process 31 to track task completion/history, and to enable time-stamping of database entries for the audit of prior previously-completed business process purposes.

The algorithm design process 12 comprises an arithmetic expression language (see later). It is arranged to enable preparation of a calculation engine 32 for performing calculations and other algorithm processes associated with the task list 30. For example, the calculation engine may perform calculations based on input data (such as heat, humidity, etc.) to calculate likely demand for energy for a particular period of time. The system 10 also comprises a business process automation engine 37, arranged to execute linked tasks and processes. The engine comprises computer logic that is arranged by the user during the business process design phase and executed either automatically based on time or event-driven (e.g. change in a variable within a designated business process or an action by a counterparty) or manually by the user (e.g. daily task list).

The system 10 also comprises a data design process 13. The data design process 13 is arranged to design data processes 33. The data processes may be arranged to capture data for the calculation/algorithm engine 32 or for other purposes. They may be arranged to capture data for document population and communications. The data acquisition, dissemination and management tasks are managed by the business process automation engine 37, and operators designed by the user during the design process.

The system 10 also comprises a document management process 14. The document management process 14 is arranged to produce documents, based on templates 15. It may also enable preparation of documents from scratch. Documents may include messages, such as an e-mail for example, to a third party involved in energy trading. The document management process 14 also enables design of a document population process 34 for automatically populating documents with data from the data process 33.

The system 10 also comprises a communications management process 16 which is arranged to design a communications process 35 for communicating messages to and from the system 10. It also enables the design of communications tracking process 36 which tracks and monitors the communications and logs them, to provide an audit trail of communications.

The computer processes 11, 12, 13, 14, 15, 16 enable the development and implementation of a set of tools to deal with workflow in a complex operations business, such as energy trading operations. The processes 30, 31, 32, 33, 34, 35, 36, 37 enable the workflow to be implemented. As well as enabling the design of task organisation, the system 10 and business process automation engine also implement data processing calculation and communications, to holistically manage the workflow of complex operations.

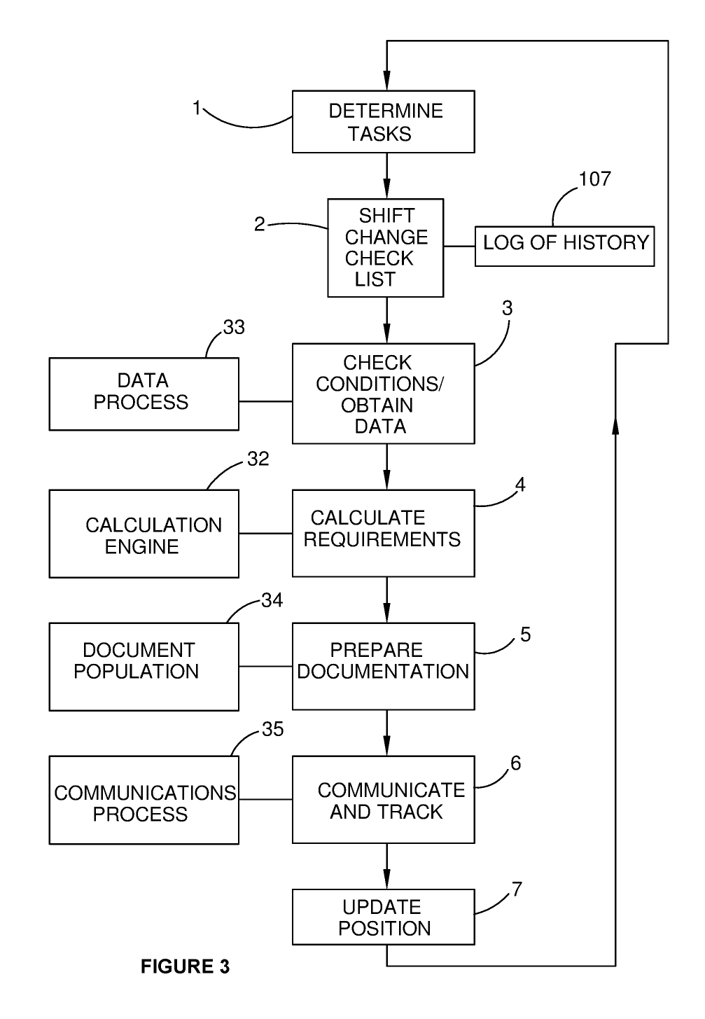

The system 10 is generic and enables design of workflow processes to deal with any complex business operations. The following example, with reference to FIGS. 3 through 10, gives an example workflow procedure implemented by the system of this embodiment for energy trading operations (in this example gas trading operations).

FIG. 3 is an example of a workflow process which may be implemented in energy (gas) trading operations. The workflow process is implemented using the system of FIG. 2.

In the example of FIG. 3, a trading operations group must determine conditions which may affect gas demand, calculate the demand, review the contract position, calculate requirements and update the position, in order to ensure that energy is provided in the most cost-effective and efficient manner (FIG. 1).

This example uses the workflow system 30 to 37 of FIG. 2, as configured by the processes 11 to 16 of the system 10 (FIG. 2).

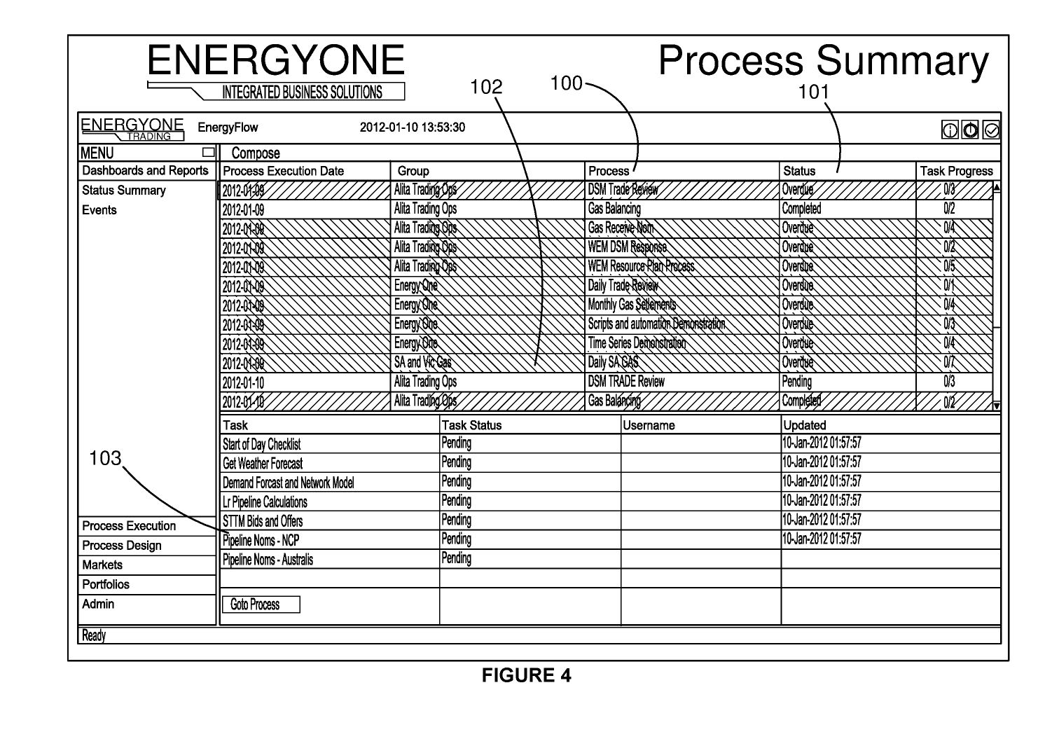

At step 1 (FIG. 3) a trader starts the day by determining the tasks they are required to implement. Accessing the system 10 via their terminals 23, 24, the operative opens a system Dashboard, as illustrated in FIG. 4. This shows a list of workflow processes 100 configured by the system 10 and their status 101. Selecting “SA and VIC Gas”, “Daily SA Gas” 102, the operative is presented with a task list 103. This gives a list of tasks that the operative is to perform for the particular process.

The operative is therefore guided through a business process for implementing this particular operation.

Some of the steps may have been automatically completed prior to the operatives' commencement. These activities (e.g. data gathering and assembly) being either routine (and therefore timer-driven) or event-driven and triggered by the logic or rules within the business process automation engine 37.

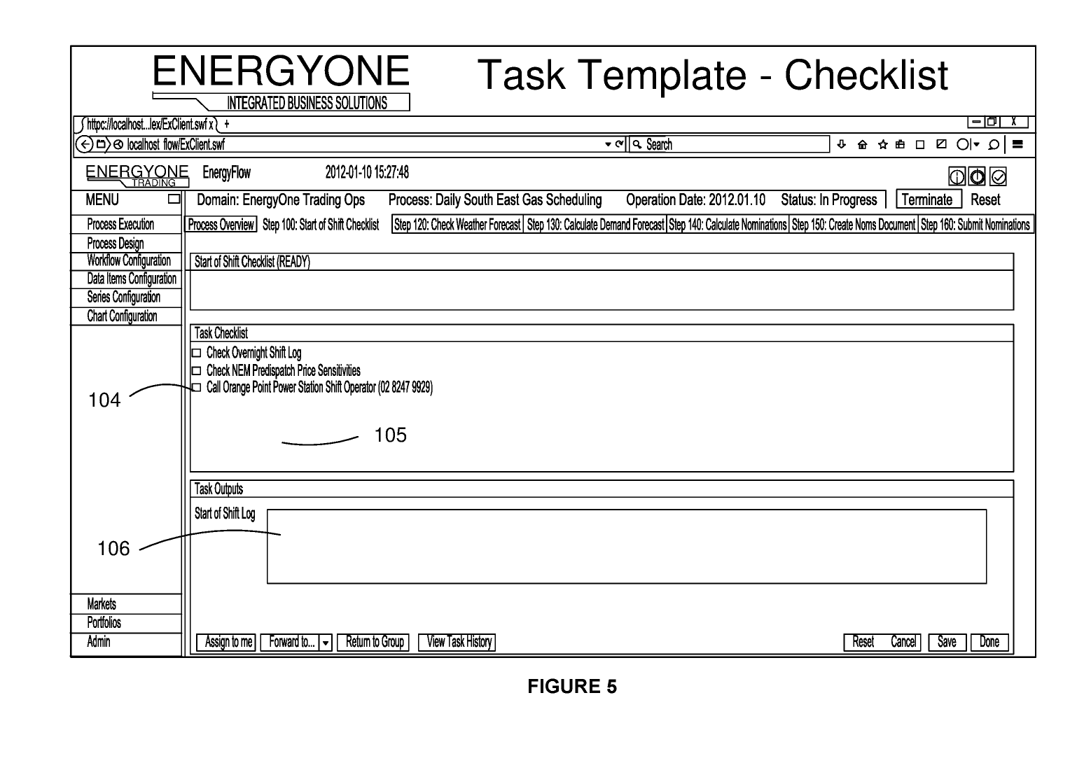

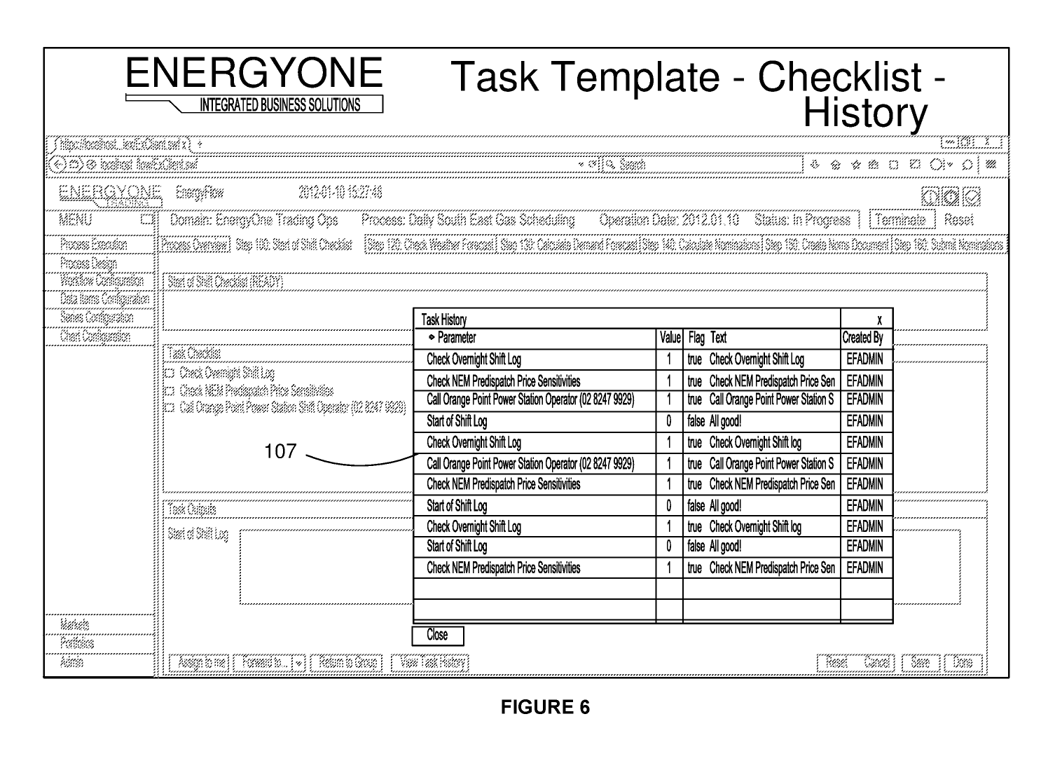

At step 2, the user accesses the Start of Day Checklist, which is the first task on the list. Referring to FIG. 5, a feature of this embodiment is a Start of Shift Checklist. This enables a user to check a history of tasks performed by a previous user to ensure that they are aware of where the trading operations are up to, and ensuring that tasks that needed to be done in the previous shift have been carried out. The Task Checklist 104 includes a task to Check Overnight Shift Log 105, as well as other tasks. Comments can be inserted by a preceding operator into the Start of Shift Log 106 for the current operator to review. Also a Task History Log 107 can be accessed by the operative (FIG. 6) to confirm that all preceding tasks have been done and bring the operative up to date. If something that should have been done in the preceding shift has not been done, the operative can add this to his task list.

The checklists and history lists are implemented by the business process 30 designed by the business management process 11. The tracking process 31 tracks completion of the task. The use of a task list reduces risk that necessary operations will not be performed. Showing a full audit trail of task history also reduces risk.

Business design process 11 incorporates an easy to understand formulaic expression language (rather than a scripting language) that contains a wide array of functions of logic, mathematics and algebra to enable business rules (whether simple or complex) to be implemented, and enables the design of the business process and task list processes 30, 31. The algorithmic business rules that apply to the tasks can be applied to the process steps to ensure tasks that are conditional upon other activities being completed or data being present are not progressed until those conditions are met, thus ensuring the process is managed accordingly.

Next task in the list 103 is Get Weather Forecast. This is part of the step of obtaining data and checking conditions (step 3, FIG. 3) that may affect gas demand.

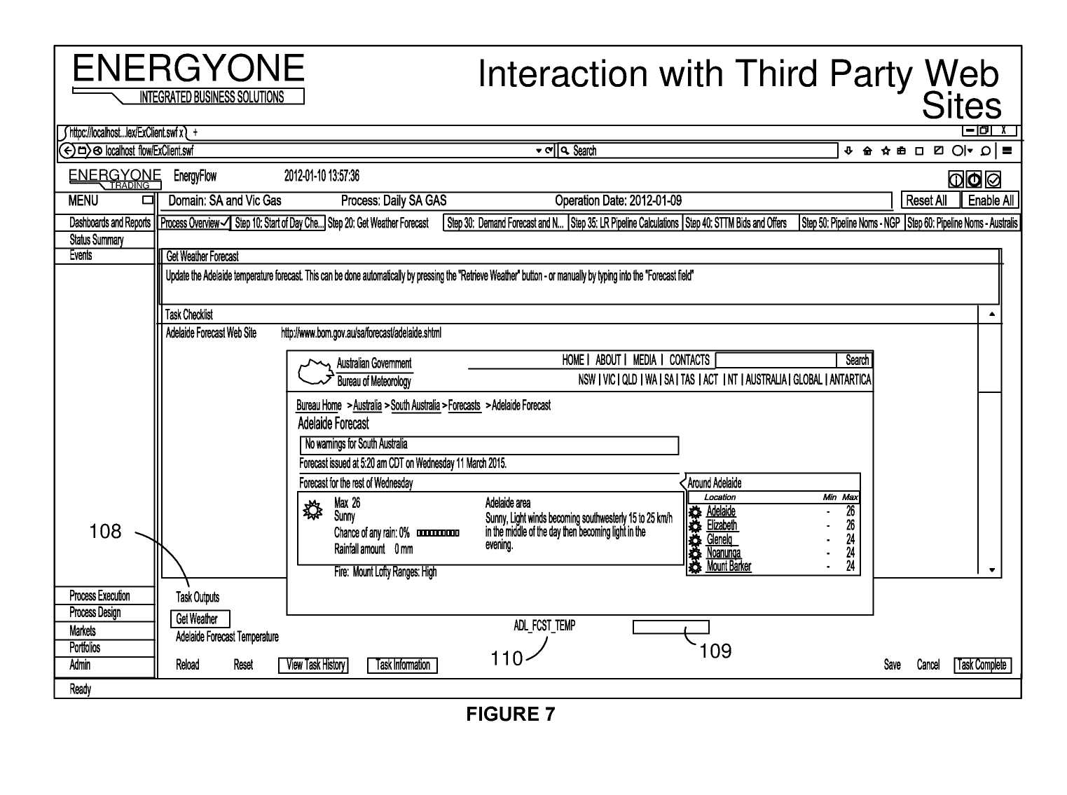

Referring to FIG. 7, this shows a screen shot of the task step Get Weather Forecast. When this step is executed by clicking on the task bar, data process 33 automatically accesses and brings up the website of the Adelaide forecast, by communicating with a third party system 25 which hosts the weather website.

Forecast temperature is data which is required for input to a calculation to determine energy demands. There may be many more data inputs than this. As well as including programming that automatically fetches the Adelaide Forecast website, in this embodiment the data process 33 is programmed to automatically fetch the forecast temperature data for use with the calculation algorithm. Operating the button 108 automatically fills in the field 109 with the Adelaide forecast temperature for the particular time period. As an alternative, if the operator chooses, they may fill in the field manually by typing into the field provided. These choices are made during a business process design activity, when the rules for each task and process are set out.

The algorithm design process 12 implements an algorithmic language, a sample of which is shown at reference 110. This is an easy to understand language that enables users to design their own algorithm using the algorithm design process 12.

The data process 33 may be configured to obtain data on all conditions that may affect energy requirements. There may be other aspects of weather data, such as wind, humidity, etc. that the data process 33 is configured to find. Other parameters will also be taken into account, such as emergencies that may affect energy supply (bushfires, transmission pipelines failing, etc.). The data process 33 may be set up, together with the business process task list 30, to obtain data for many more parameters. As well as data being automatically obtained, data may also be manually input.

At step 4 (FIG. 3) calculations are carried out by the system 10 to determine requirements. The requirements may include updating positions regarding the amount of gas supply required for a particular time period, updating positions regarding the amount of gas transport (e.g. pipeline) required, and other parameters. Calculations are performed by calculation engine 32. They may occur at different times and may be manually or automatically instigated.

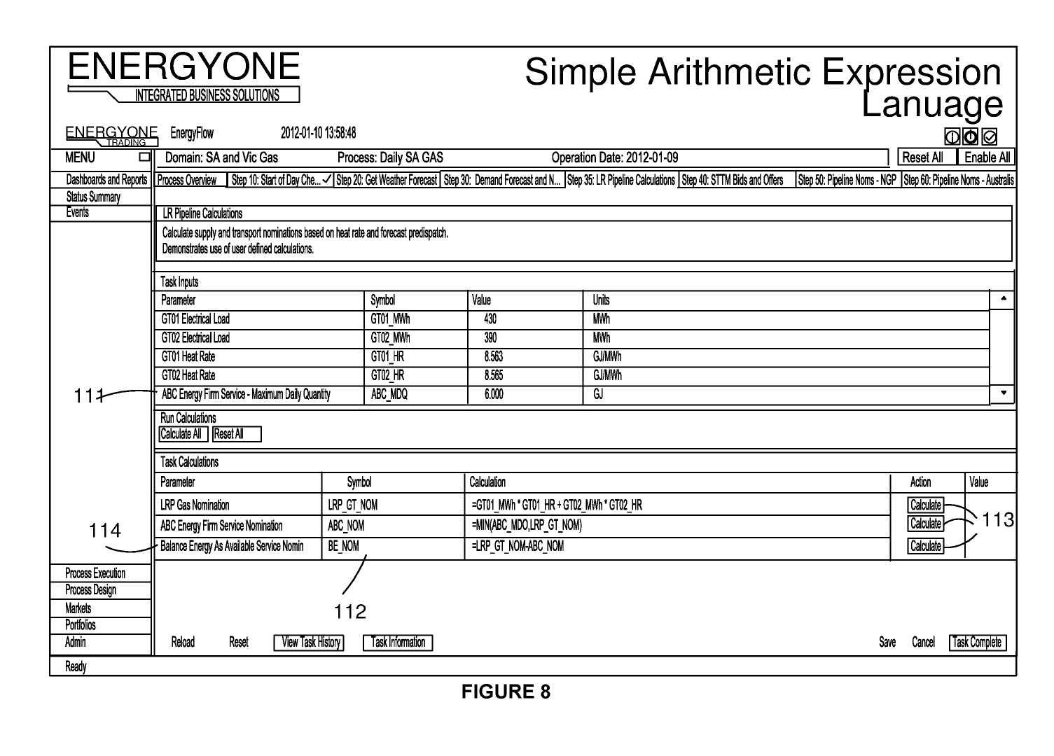

FIG. 8 shows an example LR Pipeline Calculation. Reference 111 shows input data, that may have been fetched by data process 33 or input manually. Reference 112 indicates the formula for the calculations to be carried out to calculate supply and transport nominations based on heat rate and forecast pre-dispatch. The algorithmic language is used to define the calculations. Calculations are carried out when buttons 113 are actuated by the operative. Calculations are carried out by the calculation engine 32 on the basis of the formula, to determine the nominations, indicated by reference numeral 114.

In an alternative embodiment, rather than using the calculation engine 32, users have the option of using their own calculation means. For example, some energy traders may prefer to use their own tools, such as spreadsheets. The outputs of their own tools can then be automatically input into the system, as part of the business process automation (thus integrating the system 10 with the spreadsheet tool, using a plug-in and data acquisition tool within the system, for example) as a result of the calculations e.g. gas nominations required. In this embodiment, however, it is preferred that the calculation engine 32 and algorithmic language be used for calculations. This can be automatically populated with the required input data, as discussed above.

Once requirements have been determined (at step 4), then the appropriate documentation is prepared (step 5) to implement the required updates. The document population process 34 together with data process 33 is arranged to prepare documentation. Data (e.g. content) may be loaded automatically into documents.

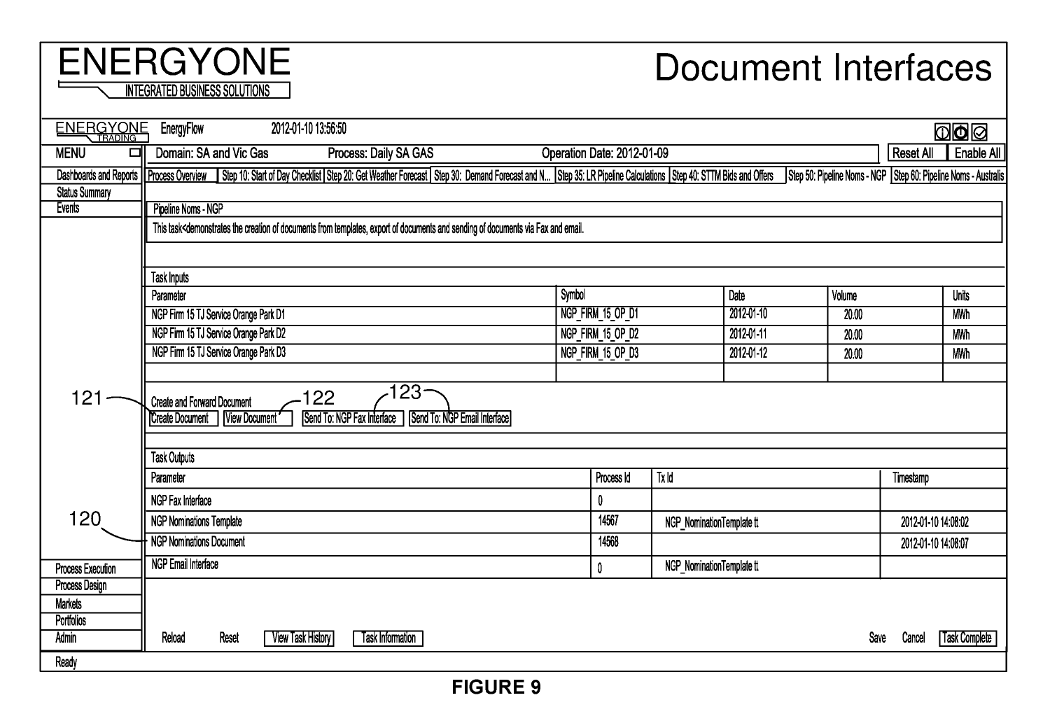

FIG. 9 is an example demonstrating the creation of documents from templates, export of documents and sending of documents via fax and email for Pipeline Noms-NGP (note that this pipeline name, and the other names in the following paragraphs, are fictional examples to illustrate operation of this embodiment of the invention). At reference 120 it can be seen that outputs of the document preparation process include an NGP Fax Interface, an NGP Nominations Template, an NGP Nominations Document and an NGP Email Interface. The document population process has access to all communications information (e.g. email and fax addresses of the appropriate party). Buttons are provided to Create Document 121, View Document 122 for review, and Sending of the documents via the appropriate interface (in this case fax or email, but could be any interface) 123. At step 6, therefore, the communications for the updated requirements are implemented via the communications process 35 and via communications 22 to third party systems 25. These communications are tracked and replies are monitored by the system 10. If replies are not received reminders are provided to operators to follow up the communications. In some cases automatic reminders may be sent.

When the position has been changed, it is updated in the system step 7 and logged in the database 21. An audit trail of all communications and replies is also logged in the database 21, for compliance and record keeping.

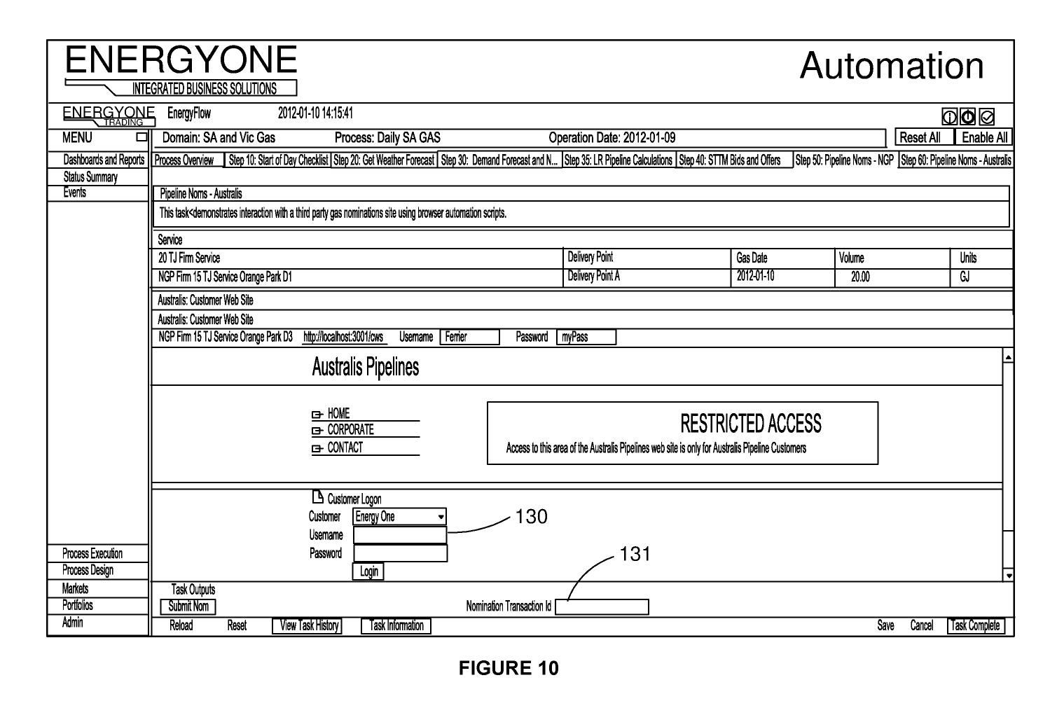

The communications process 35 also facilitates communications with third party websites. Where forms need to be filled in to update positions, for example, data process 33, communications process 35 and document population process 34 work together to automatically fill in fields. FIG. 10 shows an example where pipeline automation is implemented automatically on a third party website (Australis Customer Website). Fields such as customer field 130, nomination transaction ID, amount of nomination etc. are filled in. This is convenient and lowers the risk that errors will be made. An operative may choose to enter data manually, however, as an alternative to the automatic entering of data.

The system of this embodiment is able to manage documents in any format, including XML, CSV, PDF, HGML or any other format.

The communications process is able to manage any document exchange and communications via email, FTP, websites or any other medium.

The Business Process, task list and tracking process configured by the business management process 11 are able to manage all business processes, assign tasks, monitor process execution (notifications, alarms, etc.).

The system 10 of this embodiment also manages time series data, which is ubiquitous in the Energy Industry. Data must be tracked and tasks completed on a 24/7 basis to ensure that energy costs are optimized and compliance is managed.

The system of this embodiment also implements user based access control. Different users can have different levels of access.

The communications tracking process 36 can file documents in different places. Invoices can be logged with an account systems, for example. Documents can be distributed to different parts of an organization.

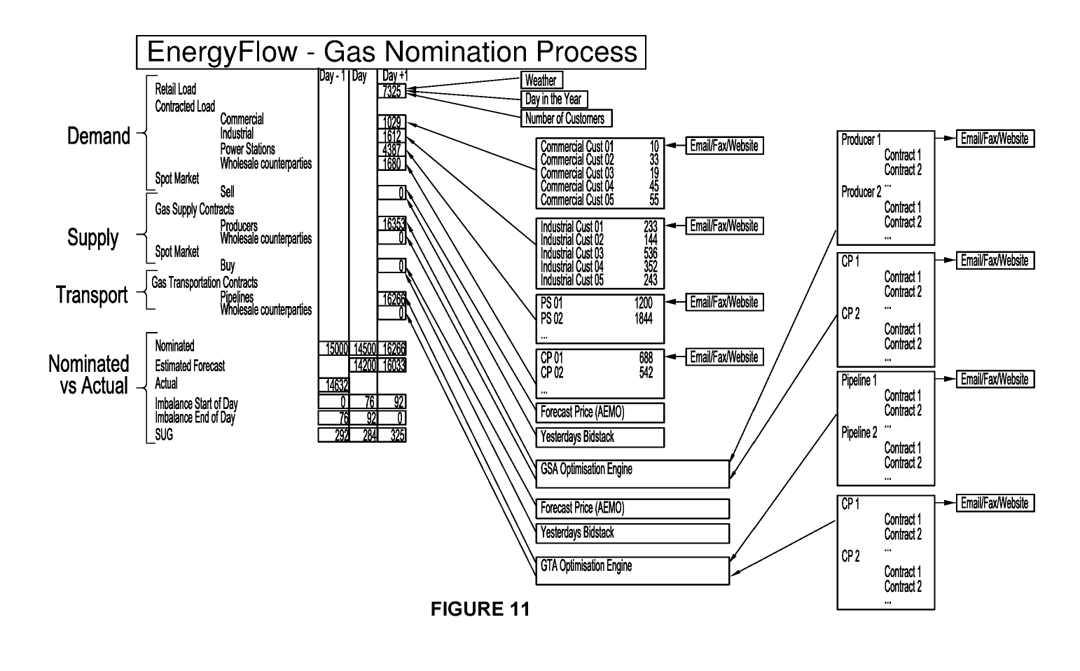

FIG. 11 illustrates a gas nomination process which may be implemented by the system of this embodiment.

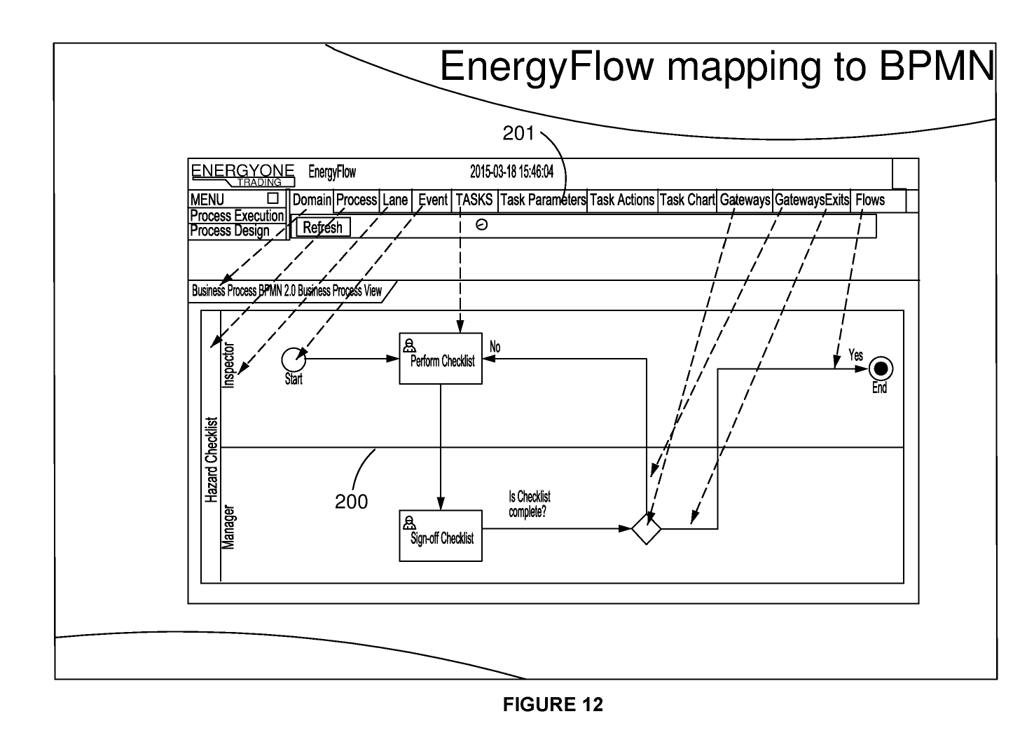

FIG. 12 illustrates how a business process flow 200 utilizes a system in accordance with an embodiment of the present invention. The various points in the business process 200, different facilities of the system are utilized, as indicated by tabs 201.

The system of the present invention is not limited to use with gas trading operations. The system can implement any business which has complex operations. Other energy businesses, for example. Electricity operations can be facilitated. There are also applications in other industries which have complex operations needs. For example, the commodities industry (mining and transport for commodities). Also there are applications in the services industry. Monitoring and determining insurance claims, for example.

Other applications for embodiments of the invention within the energy trading operations environment:
Management and scheduling of gas flows through a topographical pipeline distribution network where dependencies and constraints are required to be considered for optimal transmission and scheduling;
Preparation, submission and management of bids for electricity generators where the nature and form of the proposed bid is dependent upon a range of factors including, but not limited to fuel availability and price, customer demand, network constraints, contracted loads and the like;
Management and calculation of environmental certificate and carbon obligations and entitlements and the automated maintenance, surrender, trading and creation of certificates within central registries, especially where calculation of these obligations requires the assembly and manipulation of disparate sources of engineering data (for load or demand), contract management systems data (for inventory management and valuation) and trading data (for price discovery and bid/offer transactions);
Complex, bespoke trading contract (energy derivatives or power purchase agreement) settlements, especially where the settlement of the contract is based upon calculations from a variety of data sources, and where the use of each may be governed by potentially complex logic based upon dependencies on each other, or on pre-existing contract or inventory positions (e.g. take-or-pay, banking, green/black, fuel and other spreads, etc.);

End of month reporting where data from a variety of engineering and business systems is required to assembled and adapted to meet reporting requirements;
As a shift management and tasking application operators can take advantage of the business process automation to ease both routine shift operations tasking but also to facilitate shift change handover documentation to ensure tasks are handed over to the next shift in a clearly articulated status.

The system of this embodiment of the present invention is a generic system. Any business process can be designed by the business management process 11. Any data can be handled and calculations configured by the algorithm design process 12 and data process 13. Any document management 14 can be configured and set up via templates 15 and document management process 14. All communications can be configured by the communications manager and process 16. The system therefore provides a platform to be configured to implement complex business operations processes.

### Algorithmic Language

The algorithm Expression Language is a mathematical/algebraic language that allows users to enter customized formulas, references and logic into the configuration of workflow processes, tasks and actions. The language is designed to look very similar to the entry of formulas in spreadsheets and so should feel very comfortable to most users of Excel or anybody with a moderate level of mathematical literacy.

Expression language formulas can be used in a variety of contexts including defining how the parameter of one task can be calculated from other parameters. So for example, if we wish to calculate the forecast gas requirement for a gas fired power station and we have a task with two input parameters being:
heat rate (conversion efficiency) for the power stations in units of [GJ/MWh], labeled as HEAT_RATE
expected power output in units of [MWh], labelled as ENERGY_MWH then we could define the calculated gas consumption of the power station in a task parameter with a calculation as follows:

=HEAT_RATE*ENERGY_MWH
This calculation could be stored in a task parameter called GAS_CONSUMPTION That is, GAS_CONSUMPTION=HEAT_RATE*ENERGY_MWH.

The objectives of Expression Language include the following:
Provide a very high level of flexibility and ability to customize work process definitions
Avoid need to develop most calculations or customizations in programming or scripting languages
Be familiar to users of spreadsheets or people with moderate mathematical capabilities
Through use of meaningful symbol names (rather than spreadsheet cell references) provide a high level of readability—and hence auditability and reduced risk—in formula definitions. By default Expression Language uses symbols to reference values whereas spreadsheets by default use cell references making it difficult to understand the intent of the formula without reference to the worksheet layout
Support commonly used functions necessary for energy context including:
   Support for commonly used date expressions such as D+1 meaning ‘tomorrow’
   Support for functions on time series data—such as aggregation functions like SUM, MIN, MAX and AVG
   Support for arithmetic and logical functions commonly used in valuation, settlement and risk metric processes

The Expression Language basically consists of 3 parts:
Recognition of literal numbers—in integer, decimal or scientific format
Processing of algebraic expressions including standard arithmetic and functions
A language for referencing process and task parameters including referencing values between tasks, processes and retrieving values from earlier process executions. These references are sometimes referred to as EfReferences or Parameter References

In addition, the Expression Language contains a number of built-in functions that are designed to be similar or identical to corresponding Excel formulas to provide functionality that is specific to the energy industry context.

An object of an embodiment of the system is to reduce risk associated with execution of business processes. Supporting this objective, a control that exists around the use of the Expression Language is that expressions are stored as part of a process definition. As such:
All changes to expressions can be controlled based on role based access controls
All changes to expressions are automatically audit logged

At a technical level, the expression language is implemented using a grammar parser—rather than for example using a valuation of a subset of a scripting language—and so is protected from potential SECURITY ATTACKS. As such, the implementation is technically secure.

Expression statements can be used in several contexts within the application. These contexts include:
As task parameter calculations, so that the value for one task parameter can be calculated based on some formula using the value from other task parameters as input
As gateway exit conditions so that process flow logic may be directed in different paths based on some calculation using current process values as inputs
Within the definition of task action parameters so that the behaviour of task actions can be modified at execution time based on some calculation using current process values as inputs
As embedded statements within document templates so that the content of documents is created based on formulas using current values as inputs.

A feature of this embodiment is the tightly integrated support for time series data—where a time series is a set of data that repeats at regular periodic intervals—such as hourly or half hourly meter or market data—a key feature of many electricity markets or daily nomination or metered data is often found in gas markets. Single value data—also referred to within the system data as ‘scalar’ data—is also supported.

The expression language has been designed to support easy calculations with both series and scalar data and natural integration between the two. For example, consider that we have a time series representing half hourly electricity demand in Megawatt Hours [MWh] at a gas fired generating unit and this time series is called GT01_DEMAND_MWH and we have a scalar figure representing the conversion efficiency of the generating unit from gas in GigaJoules [GJ] to Megawatt Hours [MWh] called GT01_HEAT_RATE, then an expression to determine the half hourly gas requirement as a time series called GT01_GAS_DEMAND_GJ could be expressed like this:

GT01_GAS_DEMAND_GJ=GT01_DEMAND_MWH*GT01_HEAT_RATE

Similarly if we wish to perform simple arithmetic on two or more input time series to derive a new calculated time series we can express this in a natural way. Suppose for example we have two time series GT01_GAS_DEMAND_GJ and GT02_GAS_DEMAND_GJ representing the gas demand from two adjacent gas turbines and we wish to determine the total gas demand for both turbines as a new series called GT_TOTAL_GAS_DEMAND—GJ then we can define this calculation very simply as:

GT_TOTAL_GAS_DEMAND_GJ=GT01_GAS_DEMAND_GJ+GT02_GAS_DEMAND_GJ

The language also includes built in aggregation and selection functions to map series data to scalar data. So for example if it is desired to determine the total gas usage for a day as GT_DAY_TOTAL_GJ given a half hourly time series GT_TOTAL_GAS_DEMAND_GJ then we could define:

GT_DAY_TOTAL_GJ=SERIES_MAX(GT_TOTAL_GAS_DEMAND_GJ, ‘1-JAN-2016’, ‘2-JAN-2016’).

The Expression Language can be used to provide a very high level of customization and flexibility, while achieving a higher level of control than is available in spreadsheets and without the technical complexity of scripting.

Practical examples of where Expression Language is useful in the Energy Industry include:
Calculation of derived gas flow volumes based on arithmetic rules—such as might apply in Operational Balancing Agreements
Implementation of complex settlement calculations (e.g. tiered pricing, take or pay calculations, banking)
Implementation of complex valuation calculations
Calculation of energy flows based on combinations of forecasts, network summations and conversion factors
Implementation of business rules for operational strategy—e.g. use contract A up to limit X and then use contract B

Some more specific examples follow:

### Example of Use as Task Parameter Calculations

Given some task parameter ‘Gas Required’ we wish to calculate the gas requirement which might be simply an electricity demand requirement multiplied by some heat rate (conversion efficiency). In this case we might have

GAS_CONSUMPTION=HEAT_RATE*ENERGY_MWH

### Example of Use as Gateway Exit Condition

We might want to raise an alarm if pool prices exceed some threshold. This decision may be implemented by a gateway that will send process flow (sequence flow) to some alarm task if the pool price exceeds some threshold.

In this case we might have a formula such as this:

GATEWAY_EXIT_TO_PRICE_ALARM=IF(POOL_PRICE>1000, 1, 0)

In the above example, if the pool price variable exceeds 1000, then a 1 is returning which is logically ‘true’ in the expression language, and process flow will then pass to the task to which this gateway exist is connected.

### Example as Use as a Task Action Parameter

The system has a task action to calculate settlements over a configurable date range. If we wish to set up this action to always process the prior month, we can define task parameter calculations as indicated below:
TaskParameter: FROM_DATE
Calculation: =EOMONTH (D, −2)+1
TaskParameter: TO_DATE
Calculation: =EOMONTH (D1, −1)
   Example of Use as Embedded value in Document

The system allows process values to be embedded in document templates so that an output document can be created by replacing the embedded expression language tag with an evaluated value for the expression language statement.

For example, if we have a document template as indicated below:

GAS NOMINATION NOTIFICATION
Total Gas requirement at date {{=D+1}} at delivery point: ‘Orange Park’ is: {{HEAT_RATE*ENERGY_MW}}

In this case the document template tags as indicated by {{}} characters would be replaced by expression language calculations when the document is produced within the executing process.

### Handling of Time Series Data

A system in accordance with an embodiment of the present invention is able to process Time Series Data.

Within an embodiment of the system, Time Series Data refers to data sets that repeat at consistent intervals such as every 5, 30 or 60 minutes or daily. Time series data is ubiquitous in the energy industry context and includes data such as every 5, 30 or 60 minutes or daily. Time series data is ubiquitous in the energy industry context and includes data such as:
Half hourly electricity market data
Half hourly or 15 minute electricity meter data
Daily gas data
Daily weather data

A singular time series will correspond to a specific repeated measurement such as the ‘NSW Electricity Pool Price’ for which there is a price for every half hour.

The system contains some features in the implementation of time series data that support specific needs of the energy industry. These include:
The ability to have multiple versions of a time series measurement. This is particularly important for data such as gas flows or electricity flows that are metered at a point and where measurements may be estimated and then revised more than once so that for any point in time there may be multiple revisions of a time series point. The system stores all revisions of a time series measurement.
The ability to attach an industry specific quality to a time series measurement. Within the Energy Industry, with data such as gas flows or electricity flows it is usual to attach a context specific quality to each measurement. So for example with gas flows the quality of a measurement for any given point in time may vary through qualities of ‘nominated’, ‘scheduled’, ‘dispatched’, ‘actual’, ‘revised’, while for electricity metered flows, the quality for a given point in time may vary through ‘estimated’, ‘actual’, ‘revision’, ‘revision2’. In both cases the later revisions are normally of higher quality and are more accurate.
The need to support large volumes of time series data
The regular periodicity of data (as opposed to irregular samples that might occur with say SCADA/Plant Historian systems)
The need to support high performance/low latency calculations and transactions

Functionally, time series are managed very similarly to singular task parameters—or ‘scalar’ values—within the system.

Each time series is normally declared as part of process definition. The key point of series declaration is to assign a name to a series such as ‘NSW_POOL_PRICE’. Additional a ‘quality context’ can be assigned to define the quality codes that may apply to each time series point measurement.

Once a series is declared then that series may be references by a task parameter and then manipulated in a similar manner to ordinary/scalar task parameters. These manipulations may include:
Loading time series data from external sources using task actions such as the CsvReader or Sq1Data Adapter
Deriving new scalar or series values from existing scalars and series using Expression Language statements. For example, if we have data for two time series: ‘NSW_POOL_PRICE_$_MWH’ and ‘NSW_POOL_EXPOSURE_MW’ then we may calculate data for a third series NSW POOL REVENUE =NSW_POOL_PRICE_$_*NSW_POOL_EXPOSURE MW/2
Sending time series data to various outputs through task actions, for example writing series data to a CSV file using the CsvWriter task action

Within the system time series data is stored within a simple relational data model.

Various technical strategies are employed to maximize performance of time series manipulations including:
Use of database bulk insert/multi insert capabilities to improve upload performance
Use of in-memory caches within the application server
Use of SQL for some calculations to reduce latency between database and application server tiers

### Relational Data Model

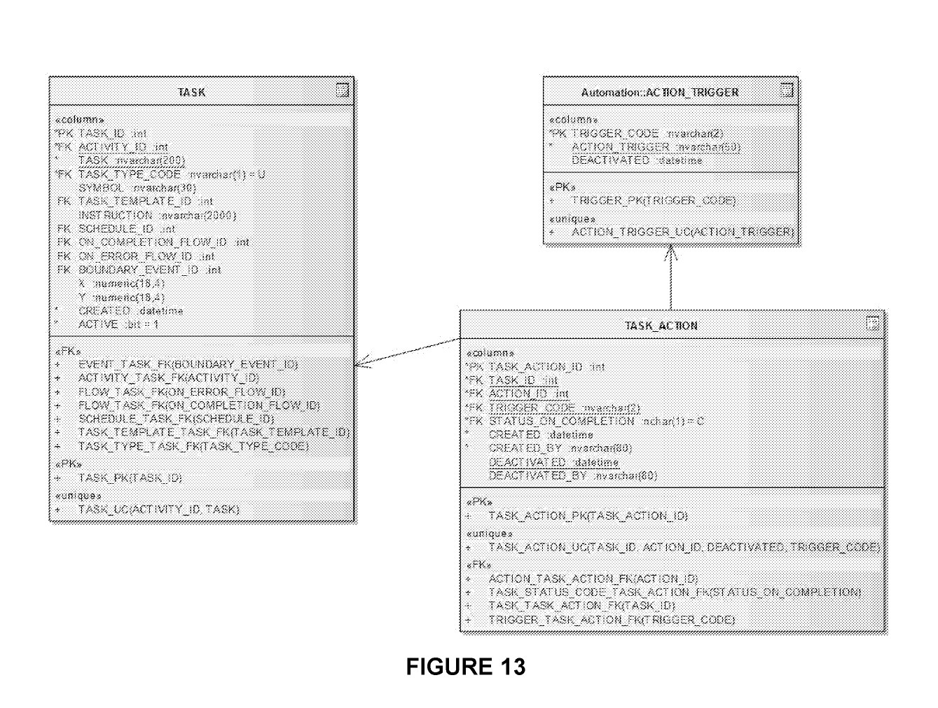

The system persists (saves) most of its data into database tables within a relational database. Within a relational database a table represents some entity (a ‘thing’) with one or more attributes represented by table columns. The diagram shown in FIG. 13 is an Entity Relationship diagram and is used to represent the tables (entities) within a database and the relationships between those entities.

FIG. 13 shows a small subset of the overall datamodel for the system and shows one of the most important tables—the TASK table and one of its relationships to another table—the TASK_ACTION table. In this diagram it is possible to see all the attributes of the TASK table including for example:
A TASK_TYPE_CODE which represents whether a task is a User task (requiring human interaction to complete) or a Service task (which will execute automatically without user interaction when sequence flow passes to the task)
An INSTRUCTION which can be optionally used to store user instructions on how to complete a task.

Each task that is configured within the system is stored as a new row within the TASK database—so that if ten tasks are configured within an instance then the TASK table will contain ten rows.

In addition to displaying the attributes of a table, the above diagram also shows other information including:
The primary key—denoted with PK on the left side of the attribute—which is a number uniquely identifying each row
The unique business key—denoted with the «unique» header—which is the set of attributes (underlined) which in a practical sense can be used to uniquely identify one row from another—which in this case is a combination of the task name (TASK attribute) along with the parent ACTIVITY (ACTIVITY_ID attribute).
The relationships with other tables—which are denoted by an FK on the left side of the attribute, the «FK» header and an arrow pointing to the related table. In the above example a TASK may have one or more related TASK_ACTIONs. A TASK_ACTION is something that a task can do such as download a file or send an email.

### Database Design

### General Principles

The following general principles have been applied to the database design:
All tables have a single attribute as the primary key. In most cases this is an integer and is stored in a column such as TASK_ID for the TASK table. In a small number of cases a character or set of characters is used as the primary key in which case the primary column will be a column named like TASK_TYPE_CODE for the TASK_TYPE table.
Most tables have a unique business key—a set of columns that uniquely identify each row from a meaningful business perspective (as opposed to the primary key column which has no particular meaning other than uniquely identifying each row). This business key is identified by a unique constraint that defines the columns that together uniquely define each row.
Where tables have a relationship, a foreign key constraint is added to the database.
Many tables have audit columns including:
   CREATED—a timestamp
   CREATED BY—a username

### Key Sub-Systems

In understanding the database design it is useful to understand some of the most important sub-systems and key tables within those sub-systems.

The process design sub-system is the set of tables that are used to capture the up-front design of a business process. Some of the most important tables within that system include the hierachy of DOMAIN←PROCESS←ACTIVITY←TASK and the tables related to a TASK including TASK_PARAMETER, TASK_VIEW, TASK_ACTION. The TASK_VIEW and TASK_ACTION tables refer to a set of ACTION and VIEW tables that define the predefined task action and task views that are available within the system.

The process execution sub-system is the set of tables that capture information whenever a process is executed. Each row within the PROCESS_EXECUTION table represents a new instance of a process that will be executed.

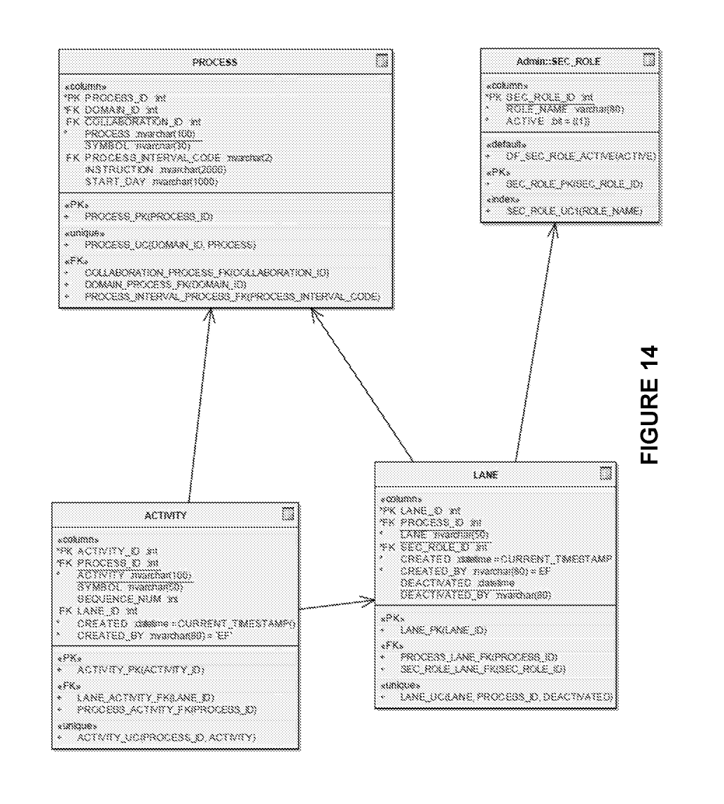

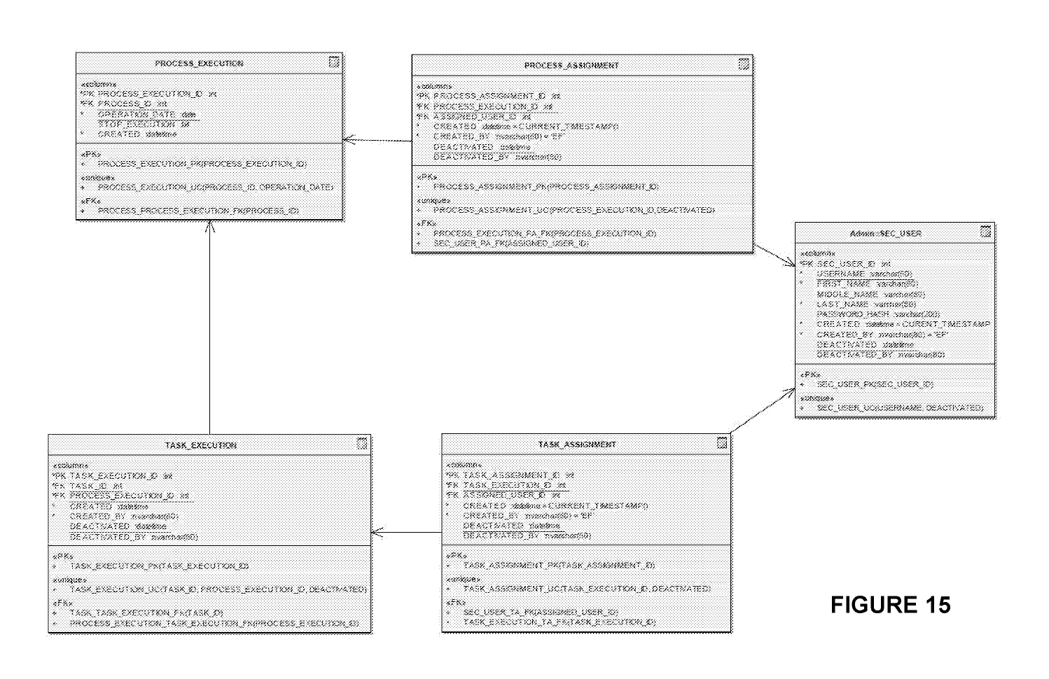

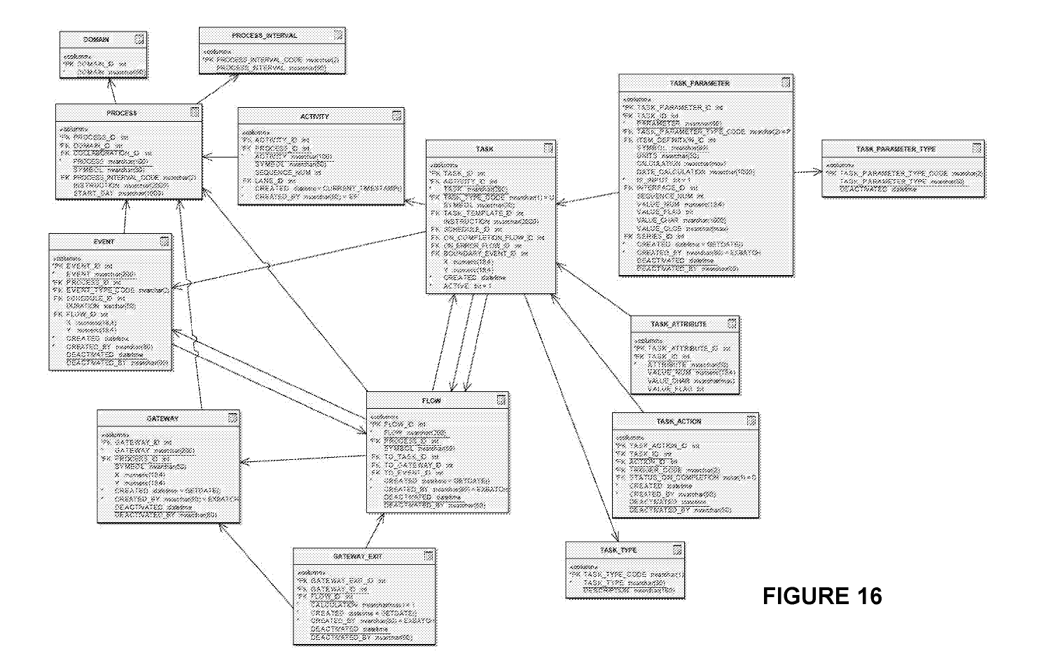

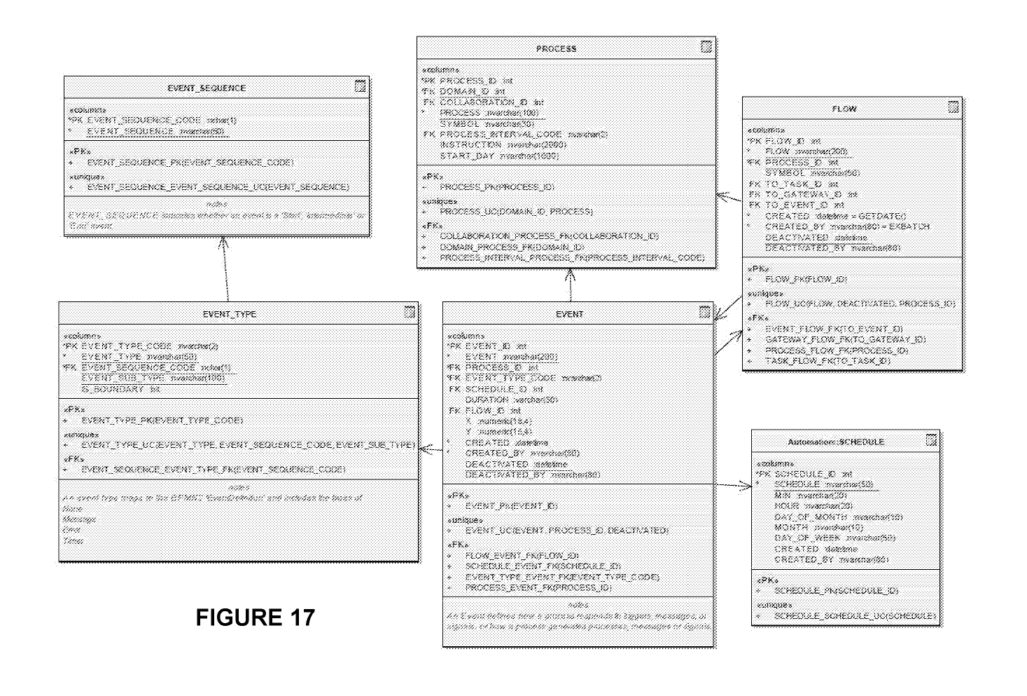

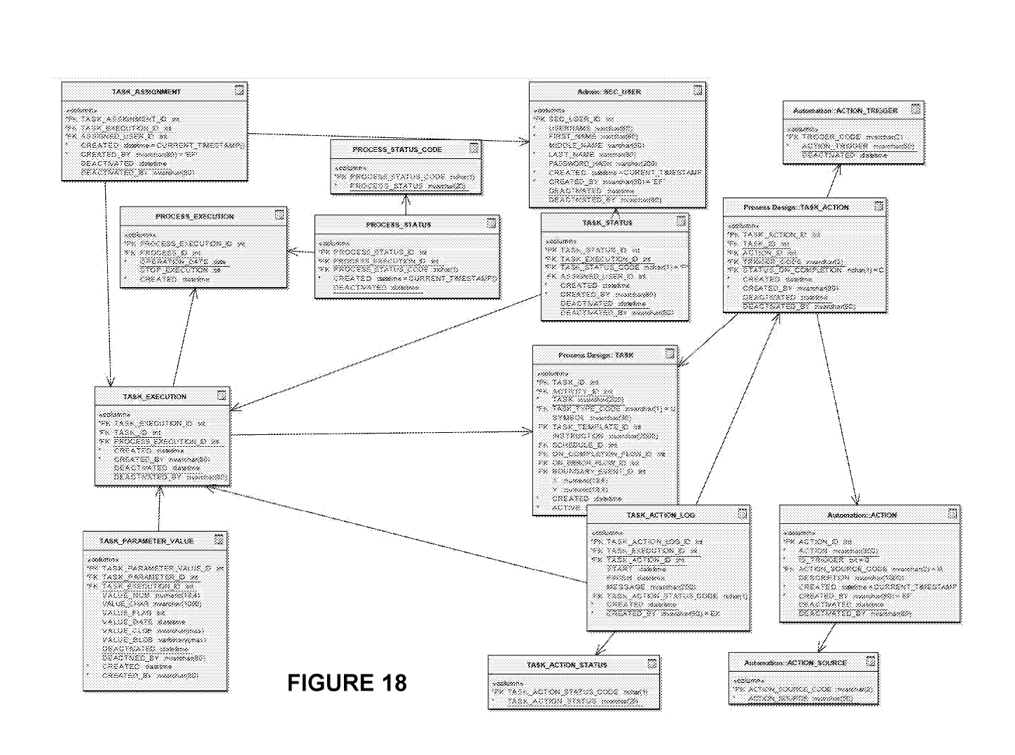

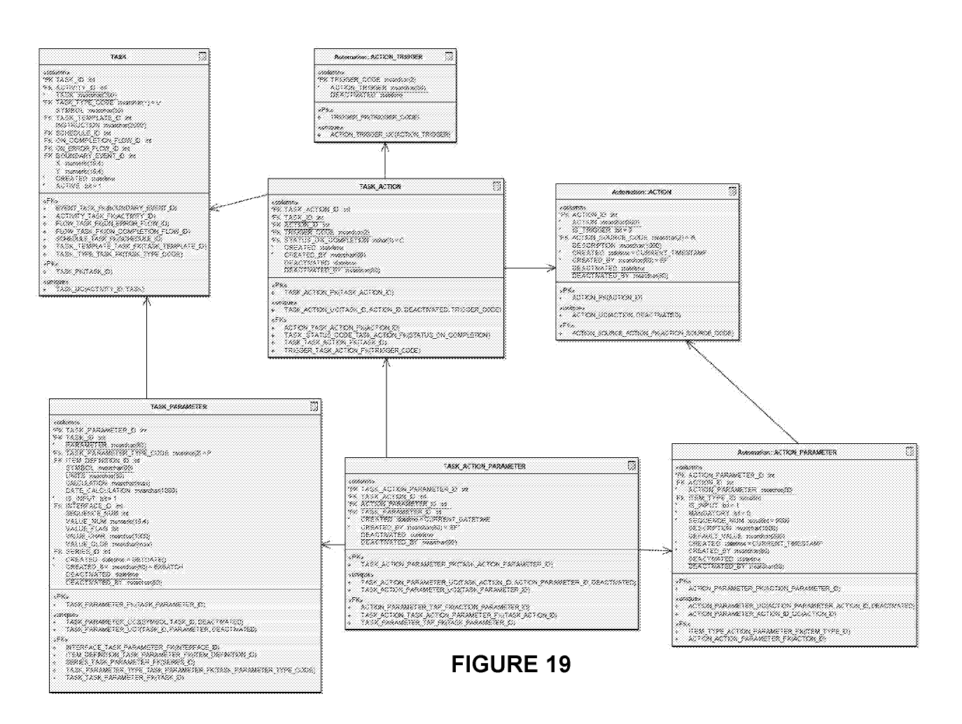

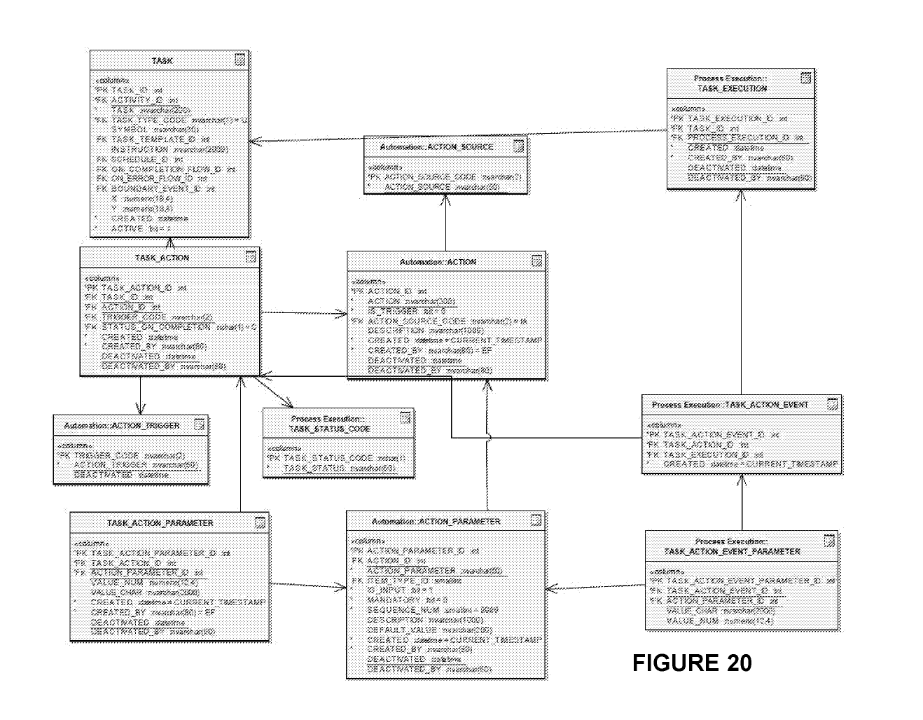

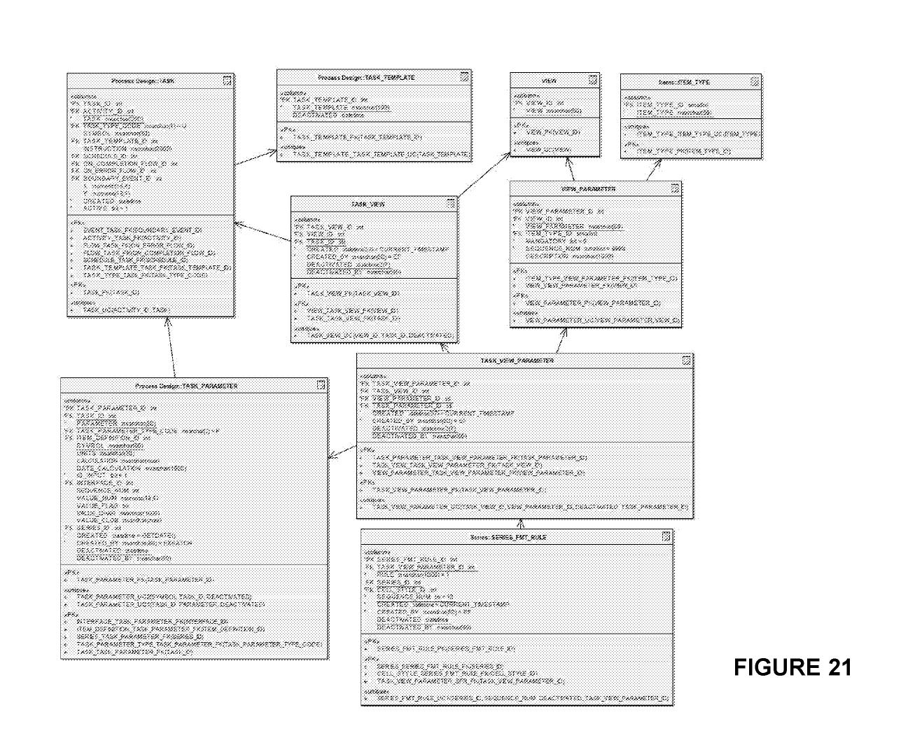

Referring to the figures:
FIG. 14 illustrates the system Pools and Lanes datamodel.
FIG. 15 illustrates the system Process Assignment datamodel.
FIG. 16 illustrates the system Process Design datamodel.
FIG. 17 illustrates the system Process Events datamodel.
FIG. 18 illustrates the system Process Execution datamodel.
FIG. 19 illustrates the system Task Action 1 datamodel.
FIG. 20 illustrates the system Task Action 2 datamodel.
FIG. 21 illustrates the system Task View datamodel.

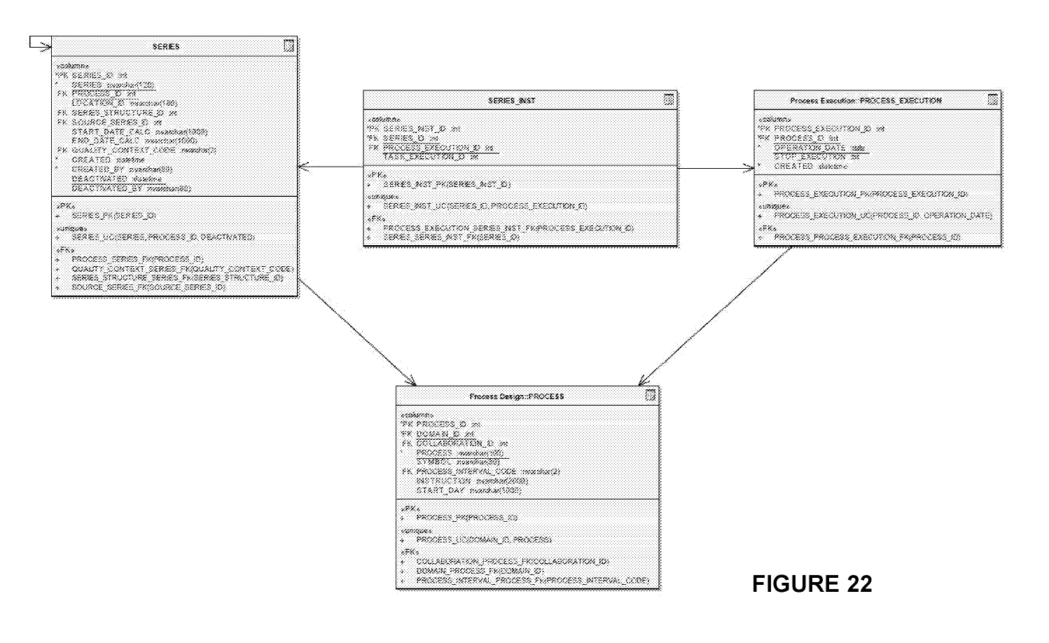

FIG. 22 illustrates the system Time Series 1 datamodel.

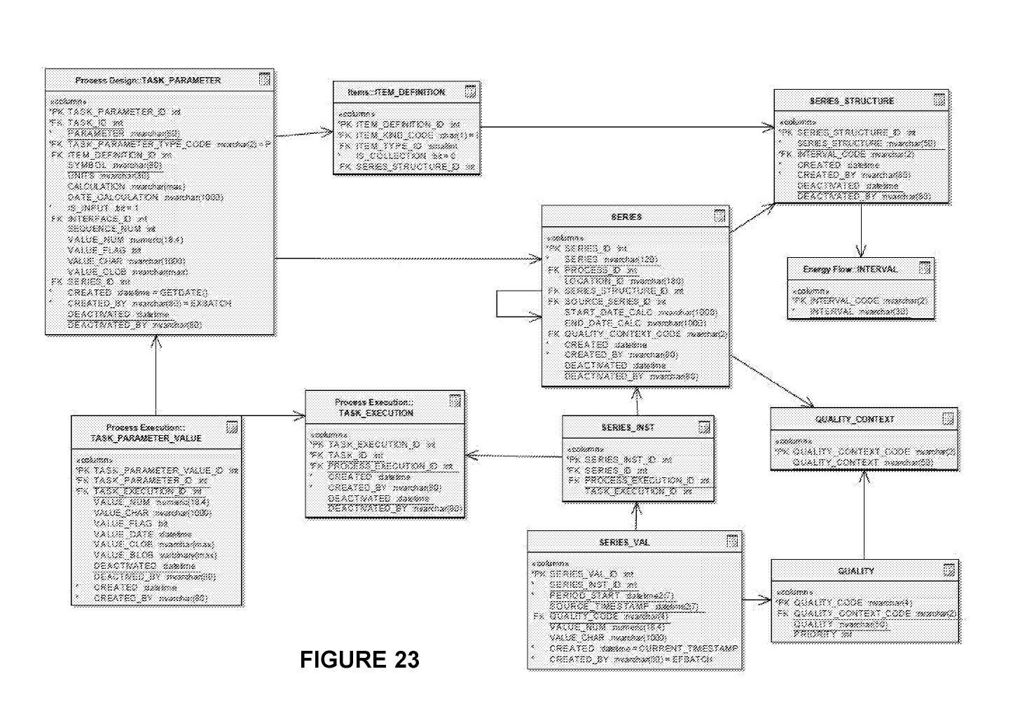

FIG. 23 illustrates the system Time Series 2 datamodel.

In the above embodiment, the apparatus comprises computer servers (which may be virtual servers in the cloud) and various software modules running on the servers to implement the processes described. Embodiments of the invention are not limited to servers and other embodiments may be implemented by a variety of hardware and software architecture. General purpose computers may be programmed to implement the apparatus and method. Any architecture could be implemented, including client server architecture, central processing unit and terminal architecture, or any other architecture. The system may be implemented utilizing mobile devices, such as tablet computers and laptop computers, or dedicated, bespoke architecture. Software may be used to program processes to implement embodiments of the invention. Programmable hardware may be used to implement embodiments, such as field programmable gate arrays, programmable gate arrays, and other hardware.

Where software is used to implement the invention, the software can be provided on computer readable media, such as discs, or as data signals over networks, such as the internet, or any other way.

The name “Energy One” used in some of the figures is a trade name. The invention is not limited in any way to use of this name. Other trade names and trademarks used in the figures are also not limiting.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for facilitating management of business operations, comprising a computer having a processor, a memory, and an operating system for implementing computer process, a business management process arranged to enable design of business process steps, and an algorithm design process arranged to enable design of algorithms for processing of data associated with one or more of the business process steps, the algorithm design process being configured to manage operation of time series data.

2. A system in accordance with claim 1, wherein the algorithm design process is arranged to enable declaration of time series as part of a process definition.

3. A system in accordance with claim 1, wherein the algorithm design process is configured to enable multiple versions of a time series measurement.

4. A system in accordance with claim 1, wherein the algorithm design process is configured to attach a specific quality to a time series measurement.

5. A system for facilitating management of business operations, comprising a computer having a processor, a memory, and an operating system for implementing computer processes, a business management process, arranged to enable the design of business process steps, and an algorithm design process, arranged to enable design of algorithms for processing of data associated with one or more of the business process steps.

6. A system in accordance with claim 5, wherein the algorithm designs process comprises an arithmetic expression language.

7. A system in accordance with claim 6, wherein the arithmetic expression language is designed for the energy trading operations industry.

8. A system in accordance with claim 5, comprising a data design process, arranged to enable design of data flow processes.

9. A system in accordance with claim 5 comprising a document management process, enabling the design of document management tasks.

10. A system in accordance with claim 9, wherein the document management tasks comprise automatic preparation of documents.

11. A system in accordance with claim 5 comprising a communications management process, enabling the design of communications tasks.

12. A system in accordance with claim 5 wherein the business management processes is arranged to enable the design of business process steps for energy operations, and the algorithmic design process is arranged to enable design of algorithms for calculation of energy operations requirements.

13. A method for facilitating management of business operations, comprising the steps of using a business management process to design a plurality of business process steps, and using an algorithm design process to design algorithms for processing of data associated with one or more of business process steps, and implementing the design process steps and algorithms to facilitate business operations.

14. A method in accordance with claim 13, wherein the business process steps are arranged for facilitating energy trading operations, and the algorithms are for implementing calculations to determine energy trading operation positions.

15-26. (canceled)
